(19) United States
(12) Patent Application Publication
(10) Pub. No.: US 2025/0019260 A1
(43) Pub. Date: Jan. 16, 2025

(54) HIGH-NICKEL TERNARY POSITIVE ELECTRODE MATERIAL HAVING HIGH THERMAL SAFETY, PREPARATION METHOD THEREFOR, AND USE THEREOF

(71) Applicant: Ningbo Ronbay New Energy Technology Co., Ltd., Yuyao Ningbo (CN)

(72) Inventors: Biwu WANG, Yuyao Ningbo (CN); Xiaoxiao HUANG, Yuyao Ningbo (CN); Jian YU, Yuyao Ningbo (CN); Hui SUN, Yuyao Ningbo (CN)

(21) Appl. No.: 18/902,111

(22) Filed: Sep. 30, 2024

Related U.S. Application Data
(63) Continuation of application No. PCT/CN2023/076050, filed on Feb. 15, 2023.

(30) Foreign Application Priority Data
Jul. 18, 2022 (CN) 202210841386.3

(51) Int. Cl. C01G 53/00; H01M 10/0525

(52) U.S. Cl. CPC C01G 53/50; H01M 10/0525; C01P 2002/88; C01P 2004/03; C01P 2006/32; C01P 2006/40

(57) ABSTRACT

The present application provides a high-nickel ternary positive electrode material having high thermal safety. According to the high-nickel ternary positive electrode material provided in the present application, significant factors affecting the thermal safety of the ternary positive electrode material are identified by measuring a thermal conductivity K, a D104 value in XRD, and a porosity α of the material. In addition, corresponding materials are prepared by means of controlling these parameters and satisfying the relationship shown in Formula I for verification. Furthermore, the high-nickel ternary positive electrode material is improved by coating with a coating material having a low thermal conductivity. The thermal conductivity of the coated material is tested, and the results indicate that with an increase in the coating amount of the coating material, the thermal conductivity of the ternary positive electrode material is in overall decrease, and the ternary positive electrode material has a better thermal safety.

### CROSS-REFERENCE TO RELATED APPLICATION

This application is a continuation of International Application No. PCT/CN2023/076050, filed on Feb. 15, 2023, which claims priority to Chinese Patent Application No. 202210841386.3, filed on Jul. 18, 2022. The disclosures of the aforementioned applications are hereby incorporated by reference in their entireties.

### TECHNICAL FIELD

The present application relates to the technical field of lithium ion batteries, and in particular to a high-nickel ternary positive electrode material having high thermal safety, a preparation method therefor, and use thereof.

### BACKGROUND

With the popularization of new energy electric vehicles and the strong support of the country for the new energy industry, positive electrode materials, as one of the main raw materials for batteries, have also received attention, of which the most prominent is ternary positive electrode materials. The most important application of these materials is power energy batteries. However, in recent years, the spontaneous combustion phenomenon of new energy vehicles has occurred frequently, thus the safety of new energy vehicles has been pushed to the forefront. In the face of such a situation, how to ensure the thermal safety of batteries has become an urgent problem for various manufacturers and research institutions, there have been some new breakthroughs from the battery level, but there are few results in positive electrode ternary materials. In the existing patent CN108550802A, the volume change of the material is reduced by doping a small amount of Y³⁺ ions and replacing some Ni³⁺ sites with La³⁺ ions to utilize electrochemical inertness of Y³⁺/La³⁺ ions during charging and discharging, thereby increasing the stability of the structure, and improving the thermal safety. In the patent CN112811403A, the stability of the crystal structure of the material is enhanced by Mg/Ti co-doping, and in combination with the coating of Li₃PO₄, layered distribution of doping and coating is achieved. The Li₃PO₄ coating layer enhances the surface stability, helps to reduce the electrochemical impedance and side reactions of the electrolyte solution, thereby improving the thermal stability of the high-nickel ternary positive electrode material.

In most of the existing technologies, the stability of the structure of a material is enhanced by doping electrochemically inert substances, and coating substances with stabilizing properties to isolate the contact between the ternary positive electrode material and HF, inhibiting the heat release due to the decomposition of material and the precipitation of metals. However, doping this kind of electrochemical inert substances has a great influence on the electronic conductivity and reaction activity of material itself, which is disadvantageous to the electrochemical performance of the material, and at the same time, this kind of multielement doping and multistep coating process increases the cost and the complexity of the manufacturing process.

### SUMMARY

In view of this, the technical problem to be solved by the application is to provide a high-nickel ternary positive electrode material having high thermal safety, a preparation method therefor, and a use thereof. The high-nickel ternary positive electrode material provided by the present application has an overall lower thermal conductivity, better thermal safety, and good electrical properties. High nickel means that is the molar ratio of Ni is >80% based on the molar ratio of Ni content in the final product.

The present application provides a high-nickel ternary positive electrode material having high thermal safety, and the high-nickel ternary positive electrode material has a chemical formula of:

LiNiₐCo_{b}Mn_{c}M_{d}QₑO₂,
where 0.8<a<0.95, b<0.2, c<0.2, d<0.1, a+b+c+d+e=1,
M is a doping element, selected from one or more of Sr, Ti, Al, Zr, Y, Ba, Mg, or Mo,
Q is a coating element, selected from one or both of Sr or Ti,
the high-nickel ternary positive electrode material satisfies a relationship shown in Formula I:

$$γ = α * D 104 / K \qquad Formula I$$

In Formula I, 0.73≤γ≤14.00, γ is a thermal safety coefficient of the high-nickel ternary positive electrode material, α is a cross-sectional porosity of the high-nickel ternary positive electrode material, D104 is a parameter of the high-nickel ternary positive electrode material in a XRD test, and K is a thermal conductivity of the high-nickel ternary positive electrode material.

In an implementation, 45≤D104≤70.

In an implementation, 1%≤α≤5%.

In an implementation, 0.1W/(m·K)≤K≤0.6 W/(m·K).

In an implementation, a core as well as a coating layer is included, and the coating layer has a thermal conductivity of ≤0.2 W/(m·K).

The present application also provides a method for preparing the above-described high-nickel ternary positive electrode material, including the following steps:
A) mixing a ternary hydroxide precursor NiₐCo_{b}Mn_{c}(OH)₂, a lithium source, and a compound containing the element M, and then sintering under an oxygen atmosphere to obtain a sintered product;
B) washing and drying the sintered product, mixing the sintered product with a compound containing the element Q, and then sintering under the oxygen atmosphere to obtain the high-nickel ternary positive electrode material.

In an implementation, the lithium source is selected from LiOH;
the compound containing the element M is selected from one or more of Al(OH)₃, Al₂O₃, SrO, TiO₂, ZrO₂, Zr(OH)₄, Y₂O₃, BaCO₃, MgO, or MoO₃;
the compound containing the element Q is selected from TiO₂, SrO, or SrTiO₃.

In an implementation, in step A), the sintering is performed at a temperature of 740° C.-820°° C. for a time of 10-15 hours.

In an implementation, in step B), the sintering is performed at a temperature of 350-500° C. for a time of 8-12 hours.

The application also provides a lithium ion battery including the high-nickel ternary positive electrode material described as above.

Compared with the prior art, the present application provides a high-nickel ternary positive electrode material having high thermal safety, the chemical formula of the high-nickel ternary positive electrode material is: LiNiₐCo_{b}Mn_{c}M_{d}QₑO₂, where 0.8<a<0.95, b<0.2, c<0.2, d<0.1, a+b+c+d+e=1; M is a doping element, selected from one or more of Sr, Ti, Al, Zr, Y, Ba, Mg, or Mo; Q is a coating element, selected from one or both of Sr or Ti; the high-nickel ternary positive electrode material satisfies the relationship shown in Formula I: γ=α*D104/K; in Formula I, 0.73≤γ≤14.00, γ is a thermal safety coefficient of the high-nickel ternary positive electrode material, α is a cross-sectional porosity of the high-nickel ternary positive electrode material, D104 is a parameter in a XRD test for the high-nickel ternary positive electrode material, and K is a thermal conductivity of the high-nickel ternary positive electrode material. According to the high-nickel ternary positive electrode material provided in the present application, significant factors affecting the thermal safety of the ternary positive electrode material are identified by measuring the thermal conductivity K, the D104 value in XRD, and the porosity α of the material. In addition, corresponding materials are prepared by means of controlling these parameters and satisfying the relationship shown in Formula I for verification. Furthermore, the high-nickel ternary positive electrode material is improved by coating with a coating material having a low thermal conductivity. The thermal conductivity of the coated material is tested, and the results indicate that with an increase in the coating amount of the coating material, the thermal conductivity of the ternary positive electrode material is in overall decrease, and the ternary positive electrode material has a better thermal safety.

### BRIEF DESCRIPTION OF DRAWINGS

FIG. 1 shows a cross-sectional pore distribution diagram of sample A.

FIG. 2 shows a cross-sectional pore distribution diagram of sample B.

FIG. 3 shows a cross-sectional pore distribution diagram of sample C.

FIG. 4 shows a cross-sectional pore distribution diagram of sample D.

FIG. 5 shows a cross-sectional pore distribution diagram of sample E.

FIG. 6 shows a SEM diagram of a surface of Sample F.

FIG. 7 shows a SEM diagram of a surface of Sample G.

FIG. 8 shows a SEM diagram of a surface of Sample H.

FIG. 9 shows a SEM diagram of a surface of Sample I.

FIG. 10 shows a comparison of DSC data of samples A-E.

FIG. 11 shows a comparison of DSC data of samples A, F, G and H

FIG. 12 shows DSC data of sample I.

### DESCRIPTION OF EMBODIMENTS

The present application provides a high-nickel ternary positive electrode material having high thermal safety, and the chemical formula of the high-nickel ternary positive electrode material is:

LiNiₐCp_{b}Mn_{c}M_{d}QₑO₂
where 0.8<a<0.95, b<0.2,c<0.2,d<0.1,a+b+c+d+e=1,
M is a doping element, selected from one or more of Sr, Ti, Al, Zr, Y, Ba, Mg, or Mo,
Q is a coating element, selected from one or both of Sr or Ti,
the high-nickel ternary positive electrode material satisfies a relationship shown in Formula I:

$$γ = α * D 104 / K \qquad Formula I$$

In Formula I, 0.73≤γ≤14.00, γ is a thermal safety coefficient of the high-nickel ternary positive electrode material, α is a cross-sectional porosity of the high-nickel ternary positive electrode material, D104 is a parameter of the high-nickel ternary positive electrode material in a XRD test, and K is a thermal conductivity of the high-nickel ternary positive electrode material.

In the present application, the chemical formula of the high-nickel ternary positive electrode material is:

LiNiₐCo_{b}Mn_{c}M_{d}QₑO₂,
where 0.8<a<0.95, b<0.2,c<0.2, d<0.1, a+b+c+d+e=1. In addition, b, c, and d are not zero.

M is a doping element, selected from one or more of Sr, Ti, Al, Zr, Y, Ba, Mg, or Mo, in an implementation, Al, Mo, Sr, and Zr.

Q is a coating element, selected from one or both of Sr or Ti, in an implementation, both Sr and Ti.

In the present application, the high-nickel ternary positive electrode material includes a core and a coating layer,
where the chemical formula of the core is LiNiₐCO_{b}Mn_{c}M_{d}O₂.

The coating layer is an oxide containing the element Q, and the coating layer has a thermal conductivity of ≤0.2 W/(m·K). In the present application, the thermal conductivity of the ternary material can be reduced by coating a material having a low thermal conductivity.

In the present application, the high-nickel ternary positive electrode material satisfies the relationship shown in Formula I:

$$γ = α * D 104 / K \qquad Formula I$$

In Formula I, γ is a thermal safety coefficient of the high-nickel ternary positive electrode material; in the present application, the γ value is controlled between 0.73 and 14.00. When γ is lower than 0.73, a DSC peak temperature will be lower than 213° C., and the high nickel ternary positive electrode material has a poor thermal safety. When the γ value is between 0.73 and 14.00, the high nickel ternary positive electrode material has a high thermal safety; in an implementation, the γ value is controlled between 1.07 and 14.00, the high nickel ternary positive electrode material has a higher thermal safety; further in an implementation, the γ value is controlled between 1.45 and 13.13; more in an implementation, the γ value is controlled between 7.74 and 13.13.

α is a cross-sectional porosity of the high-nickel ternary positive electrode material. High porosity can reduce the overall thermal conductivity of the high-nickel ternary positive electrode material, and play a role in slowing down the inward transfer of heat generated by side reactions on the surface of the material, thereby effectively improving the stability of the internal structure of the material and inhibiting the occurrence of internal side reactions to improve the thermal safety of the material. In the present application, 1%≤α≤5%, in an implementation, α is 1%, 2%, 3%, 4%, 5%, or any numerical value between 1%-5%.

D104 is a parameter of the high-nickel ternary positive electrode material in a XRD test. The increase of the unit cell parameter D104 for unit cells decreases the phonon thermal conductivity of the material. In the present application, 45≤D104≤70, in an implementation, D104 is 45, 50, 55, 60, 65, 70, or any numerical value between 45-70.

K is a thermal conductivity of the high-nickel ternary positive electrode material, 0.1 W/(m·K)≤K≤0.6 W/(m·K). In an implementation, K is 0.1, 0.2, 0.3, 0.4, 0.5, 0.6, or any numerical value between 0.1-0.6 W/(m·K).

The high-nickel ternary positive electrode material provided by the present application has a low thermal conductivity, so that when the material reacts with an electrolyte solution, the heat release will be delayed accordingly, thus slowing down the occurrence of side reactions.

The present application also provides a method for preparing the above-described high-nickel ternary positive electrode material, including the following steps:
A) mixing a ternary hydroxide precursor NiₐCo_{b}Mn_{c}(OH)₂, a lithium source, and a compound containing the element M, and then sintering under an oxygen atmosphere to obtain a sintered product;
B) washing and drying the sintered product, and mixing the sintered product with a compound containing the element Q, and then sintering under the oxygen atmosphere to obtain the high-nickel ternary positive electrode material.

In the present application, firstly, a ternary hydroxide precursor NiₐCo_{b}Mn_{c}(OH)₂, a lithium source, and a compound containing the element M are mixed to obtain a mixture.

Where the lithium source is selected from LiOH;
the compound containing the element M is selected from one or more of Al(OH)₃, Al₂O₃, SrO, TiO₂, ZrO₂, Zr(OH)₄, Y₂O₃, BaCO₃, MgO, or MoO₃;
the molar ratio of the ternary hydroxide precursor NiₐCo_{b}Mn_{c}(OH)₂ to the lithium source is 1:1.04;
the molar ratio of the ternary hydroxide precursor NiₐCo_{b}Mn_{c}(OH)₂ to the compound containing the element M is 1:d, where d<0.1, in an implementation 0.01-0.04.

The present application has no special limitation on the mixing method herein, and mixing methods known to persons of ordinary skill in the art are sufficient.

Then, the mixture is sintered under an oxygen atmosphere to obtain a sintered product.

Where, the sintering is performed at a temperature of 740° C.-820° C., in an implementation 740, 760, 780, 800, 820, or any numerical value between 740° C.-820° C., for a time of 10-15 hours, in an implementation 10, 11, 12, 13, 14, 15, or any numerical value between 10-15 hours.

Next, the sintered product is cooled, crushed and sieved, then washed and dried, then mixed with a compound containing the element Q, and then sintered under the oxygen atmosphere to obtain a high-nickel ternary positive electrode material.

Where the compound containing the element Q is selected from TiO₂, SrO, or SrTiO₃.

The sintering is performed at a temperature of 350-500° C., in an implementation 350, 400, 450, 500, or any numerical value between 350-500° C., for a time of 8-12 hours, in an implementation 8, 9, 10, 11, 12, or any numerical value between 8-12 hours.

The application also provides a lithium ion battery including the high-nickel ternary positive electrode material described as above.

The high-nickel ternary positive electrode material provided by the present application has a high DSC peak temperature, and thus has a high thermal safety. The thermal safety performance in the present application is characterized based on the peak value in the DSC test.

According to the high-nickel ternary positive electrode material provided in the present application, significant factors affecting the thermal safety of the ternary positive electrode material are identified by measuring the thermal conductivity K, the D104 value in XRD, and the porosity α of the material. In addition, corresponding materials are prepared by means of controlling these parameters and satisfying the relationship shown in Formula I for verification. Furthermore, the high-nickel ternary positive electrode material is improved by coating with a coating material having a low thermal conductivity. The thermal conductivity of the coated material is tested, and the results indicate that with an increase in the coating amount of the coating material, the thermal conductivity of the ternary positive electrode material is in overall decrease, and the ternary positive electrode material has a better thermal safety.

In order to further understand the present application, the high-nickel ternary positive electrode material having high thermal safety provided by the present application and the preparation method therefor and use thereof are described below in combination with embodiments, and the protection scope of the present application is not limited by the following embodiments.

### EXAMPLE

1) Sample A was LiNi_{0.908}Co_{0.048}Mn_{0.029}M_{0.015}O₂, M was Al, where α, D104, K, and γ were 1%, 45, 0.62, and 0.73, respectively.

### Preparation Method

(1) the hydroxide Ni_{0.92}Co_{0.05}Mn_{0.03} (OH)₂, LiOH, and the additive Al(OH)₃ were mixed, where the molar ratio of Ni_{0.92}Co_{0.05}Mn_{0.03} (OH)₂ to LiOH was 1:1.04, and the molar proportion of Al(OH)₃ was 0.015; the molar proportion of Al(OH)₃ refers to the molar proportion of Al element in the sum of the metal elements in the ternary positive material.
(2) the homogeneously mixed material was sintered under an oxygen atmosphere at 740° C. for 15 h, cooled, crushed and sieved.
2) Sample B was LiNi_{0.908}Co_{0.048}Mn_{0.029}M_{0.015}O₂, M was Sr, where α, D104, K, and γ were 2%, 60, 0.41, and 2.93, respectively.

### Preparation Method

(1) the hydroxide Ni_{0.92}Co_{0.05}Mn_{0.03}(OH)₂, LiOH, and the additive SrO were mixed, where the molar ratio of Ni_{0.92}Co_{0.05}Mn_{0.03}(OH)₂ to LiOH was 1:1.04, and the molar proportion of SrO was 0.015;
(2) the homogeneously mixed material was sintered under an oxygen atmosphere at 780° C. for 15 h, cooled, crushed and sieved.
3) Sample C was LiNi_{0.908}Co_{0.048}Mn_{0.029}M_{0.015}O₂, M was Zr, where α, D104, K, and γ were 3%, 70, 0.16, and 13.13, respectively.

### Preparation Method

(1) the hydroxide Ni_{0.92}Co_{0.05}Mn_{0.03}(OH)₂, LiOH, and the additive ZrO₂ were mixed, where the molar ratio of Ni_{0.92}Co_{0.05}Mn_{0.03}(OH)₂ to LiOH was 1:1.04, and the molar proportion of ZrO₂ was 0.015;
(2) the homogeneously mixed material was sintered under an oxygen atmosphere at 820° C. for 15 h, cooled, crushed and sieved.
4) Sample D was LiNi_{0.908}Co_{0.048}Mn_{0.029}M_{0.015}O₂, M was Y, where α, D104, K, and γ were 4%, 60, 0.31, and 7.74, respectively.

### Preparation Method

(1) the hydroxide Ni_{0.92}Co_{0.05}Mn_{0.03}(OH)₂, LiOH, and the additive Y₂O₃ were mixed, where the molar ratio of Ni_{0.92}Co_{0.05}Mn_{0.03}(OH)₂ to LiOH was 1:1.04, and the molar proportion of Y₂O₃ was 0.015;
(2) the homogeneously mixed material was sintered under an oxygen atmosphere at 780° C. for 15 h, cooled, crushed and sieved.
5) Sample E was LiNi_{0.908}Co_{0.048}Mn_{0.029}M_{0.015}O₂, M was Mo, where α, D104, K, and γ were 3%, 70, 0.25, and 8.4, respectively.

### Preparation Method

(1) the hydroxide Ni_{0.92}Co_{0.05}Mn_{0.03}(OH)₂, LiOH, and the additive MoO₃ were mixed, where the molar ratio of Ni_{0.92}Co_{0.05}Mn_{0.03}(OH)₂ to LiOH was 1:1.04, and the molar proportion of MoO₃ was 0.015;
(2) the homogeneously mixed material was sintered under an oxygen atmosphere at 800° C. for 15 h, cooled, crushed and sieved.
6) Sample F was obtained by coating sample A with 1000 ppm of coating agent Q. Sample F was LiNi_{0.9075}Co_{0.048}Mn_{0.029}M_{0.015}Q_{0.0005}O₂, M was Al, Q was Sr, where α, D104, K, and γ were 1%, 45, 0.53, and 0.85, respectively.

Preparation method: Sample A was washed with water in a water-to-material ratio of 1:1 and then centrifuged and dried at 140° C. for 12 h, then homogeneously mixed with 1000 ppm SrO, and then sintered at 500° C. for 12 h under an oxygen atmosphere to obtain sample F.
7) Sample G was obtained by coating sample A with 3000 ppm of coating agent Q. Sample G was LiNi_{0.9065}Co_{0.048}Mn_{0.029}M_{0.015}Q_{0.0015}O₂, M was Al, Q was Ti, where α, D104, K, and γ were 1%, 45, 0.42, and 1.07, respectively.

Preparation method: Sample A was washed with water in a water-to-material ratio of 1:1 and then centrifuged and dried at 140°° C. for 12 h, then homogeneously mixed with 3000 ppm TiO₂, and then sintered at 500° C. for 12 h under an oxygen atmosphere to obtain sample G.
8) Sample H was obtained by coating sample A with 5000 ppm of coating agent Q. Sample H was LiNi_{0.9055}Co_{0.048}Mn_{0.029}M_{0.015}Q_{0.0025}O₂, M was Al, Q was Sr and Ti, where α, D104, K, and γ were 1%, 45, 0.31, and 1.45, respectively.

Preparation method: Sample A was washed with water in a water-to-material ratio of 1:1 and then centrifuged and dried at 140° C. for 12 h, then homogeneously mixed with 5000 ppm SrTiO₃, and then sintered at 500° C. for 12 h under an oxygen atmosphere to obtain sample G.

### Comparative Example

1) Sample I was LiNi_{0.92}Co_{0.05}Mn_{0.03}O₂, where α, D104, K, and γ were 1%, 40, 0.86, and 0.47, respectively.

Preparation method:
(1) the hydroxide Ni_{0.92}Co_{0.05}Mn_{0.03}(OH)₂ and LiOH were mixed according to the molar ratio of 1:1.04;
(2) the homogeneously mixed material was sintered under an oxygen atmosphere at 740° C. for 15 h, cooled, crushed and sieved.

The performances of the above obtained samples A˜I were tested as follows:
1. DSC test
(1) A positive electrode material and acetylene black according to the mass ratio of 98:2 were disperse in a NMP solution, in which PVDF having a concentration of 5% is dissolved, and stirred for 20 min, where the concentration of the positive electrode material is 60%.
(2) The obtained slurry was uniformly coated in an aluminum foil and dried at 110° C. for 4 hours in a vacuum drying oven.
(3) The dried electrode sheet was cut into circular sheets having a diameter of 15 mm, and a positive electrode shell, electrode sheet, an electrolyte solution (EC/DMC/EMC with a volume ratio of 1:1:1, LiPF6 having a concentration of 1 mol/L is included), a separator (CelgardPP/PE/PP, a three-layer composite membrane), a lithium sheet, the electrolyte solution, nickel foam, and a negative electrode shell were assembled and sealed to obtain a battery in a glove box,
(4) The obtained battery was stood for 24 hours and then charged using a current of 0.1C.
(5) The charged battery was disassembled in the glove box, and the obtained electrode sheet was subjected to NMP cleaning and drying for DSC test. In the glove box, 2˜3 mg of the positive electrode sheet was taken and placed at the bottom of a crucible, into which 1.7 mg of 1mol/L of a LiPF₆ solution (in which solvents include EC and DMC with a volume ratio of 1:1) was dropped, so that the LiPF₆ solution is uniformly distributed on the surface of the electrode sheet, and then the crucible was sealed in a special mold, and the sealed crucible was put into a differential scanning calorimeter with nitrogen gas introduced. The test was performed at a temperature rise rate of 10° C./min, the maximum temperature was set to 350° C.
2. Thermal conductivity (K) test: laser thermal conductivity analyzer LFA was used (NETZSCH, Germany). Specifically, the LFA 457 Laser Thermal Conductivity Analyzer, model NETZSCH LFA 457 MicroFlash was used. Samples are pressed disc-shaped blocks having a diameter of 12.5 mm, and a compacted density of 4.26 g/ml; the test is performed at a temperature increase rate of 5K/min from 20° C. to 900° C. under vacuum condition to get the thermal conductivity.
3. Porosity (α) test: a sample was subjected to an argon ion milling instrument GATAN 697 to obtain the cross section having a flat surface, which was subjected to SEM test and then software processing to obtain the porosity.
4. D104 test: XRD test of positive electrode powder was carried out by using Bruker D8A A25 X-ray diffractometer, and the unit cell parameter D104 was obtained after processing by EVA and TOPAS software.
5. Thermal safety coefficient was calculated by formula γ=α*D104/K.

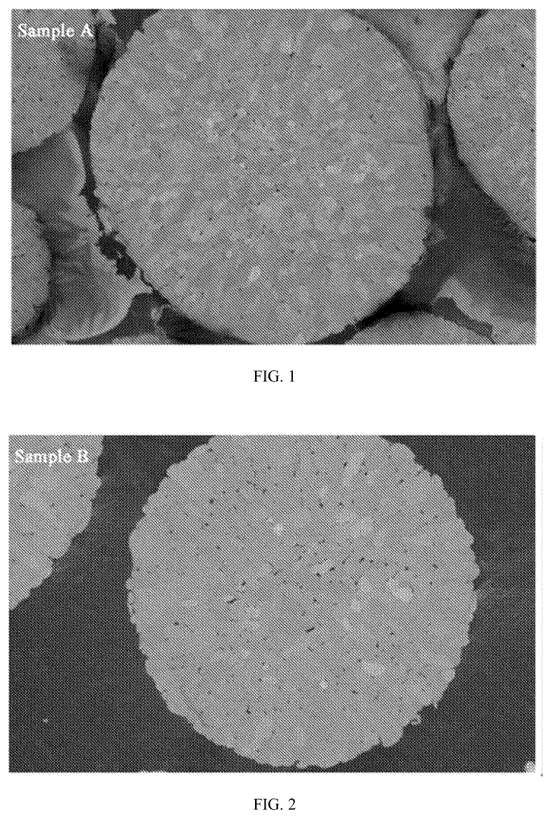

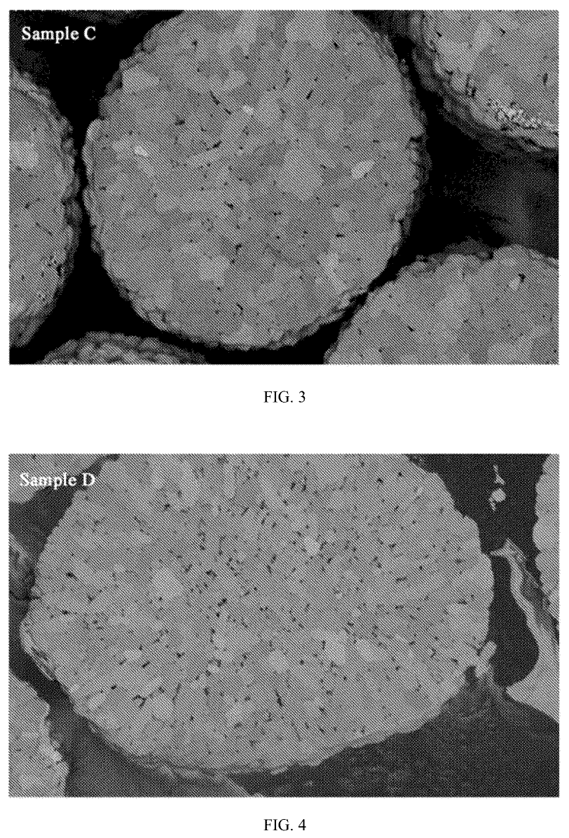

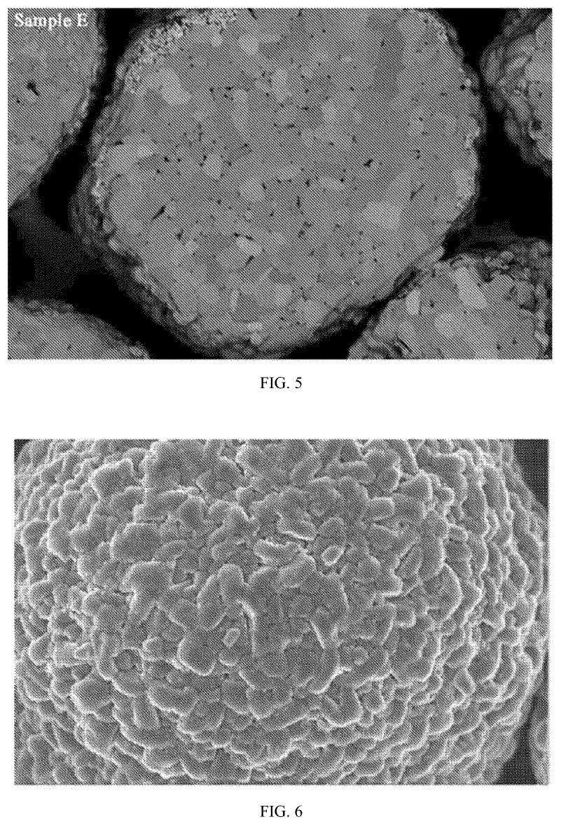

Samples A, B, C, D, and E are different in porosity α, unit cell parameter D104, and thermal conductivity K. The increase of D104 makes the layer spacing of transition metal layers of the material increase, and at the same time, the space of the Li layer is compressed to result in restricted Li ion transport and reduced ionic thermal conductivity. In addition, the increase of the crystal lattice spacing makes the phonon thermal conductivity decrease, thereby leading to the overall reduction of the thermal conductivity. When the porosity between primary particles in secondary particles is higher, the diffusion of heat from the surface to the interior of the material is impeded, resulting in a reduction of the overall thermal conductivity and inhibiting the spread of heat from the exterior to the interior of the material. FIGS. 1˜5 show the cross-sectional pore distribution of samples A-E, respectively.

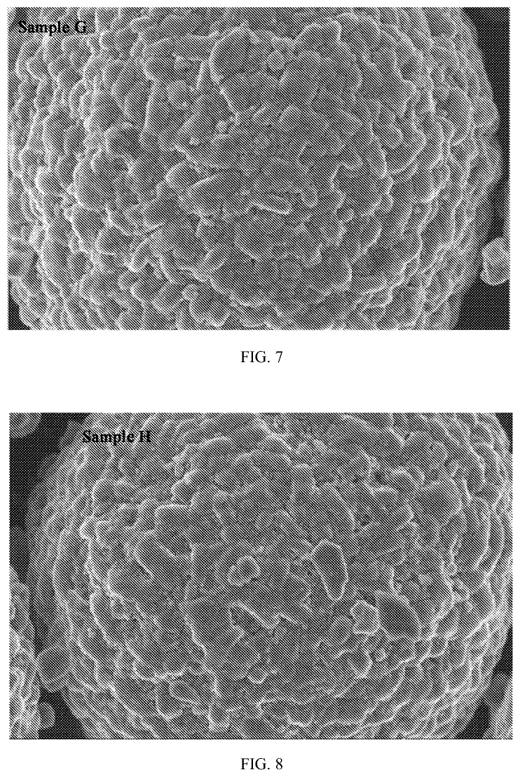

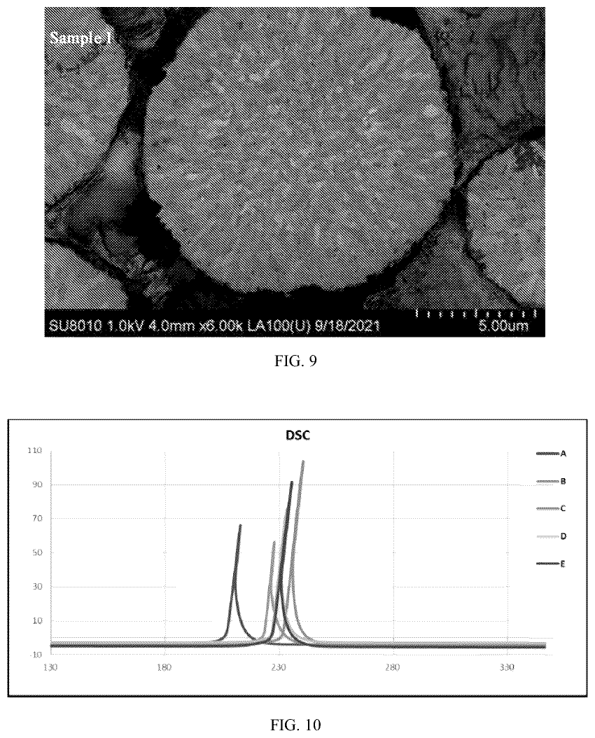

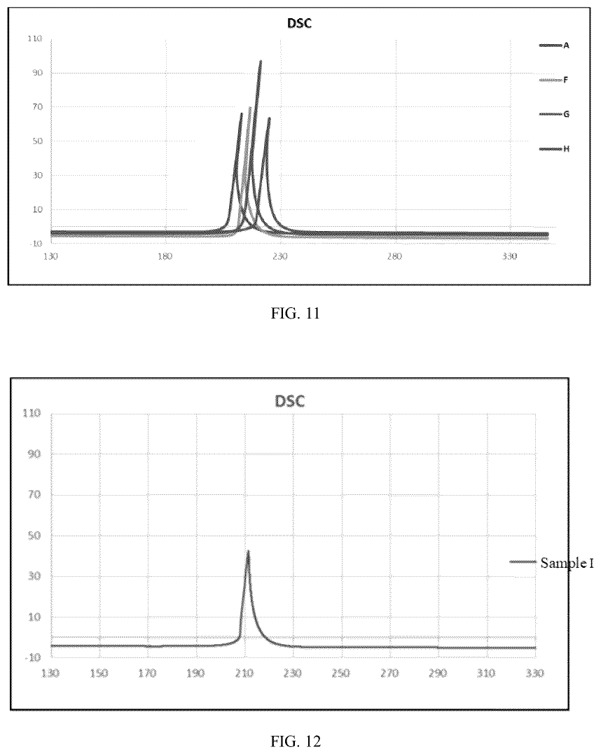

Samples F-H are a material formed by coating the sample A with 1000 ppm, 3000 ppm, or 5000 ppm of a Q-coating agent respectively, and the overall thermal conductivity of the material is decreased by coating the Q-coating material having low thermal conductivity and changing the coating amount of the Q-coating material. Therefore, the thermal conductivity of the material decrease, and thus the influence of external thermal reaction on the inside of secondary particles is reduced. In addition, the coating layer has a certain insulating effect on the material and the electrolyte solution, this can effectively inhibit side reactions on the surface of the material to reduce the heat release and the collapse of the structure of the material, thus improving the thermal safety of the material. FIGS. 6-9 show the SEM diagrams of the surfaces of sample F-I, and FIGS. 10-12 show a comparison of DSC data of different materials. In FIG. 10, the samples are A, B, D, E and C in order of peak positions from left to right; in FIG. 11, the samples are A, F, G and H in order of peak positions from left to right, and FIG. 12 shows DSC data of Sample 1.

Table 1 shows α, D104, K, γ, and DSC peaks corresponding to materials A˜I.

TABLE 1

| Sample | α | D104 | K | γ | DSC Peak temperature (° C.) |
|---|---|---|---|---|---|
| A | 0.01 | 45 | 0.62 | 0.73 | 213 |
| B | 0.02 | 60 | 0.41 | 2.93 | 227 |
| C | 0.03 | 70 | 0.16 | 13.13 | 240 |
| D | 0.04 | 60 | 0.31 | 7.74 | 233 |
| E | 0.03 | 70 | 0.25 | 8.40 | 235 |
| F | 0.01 | 45 | 0.53 | 0.85 | 216 |
| G | 0.01 | 45 | 0.42 | 1.07 | 221 |
| H | 0.01 | 45 | 0.31 | 1.45 | 225 |
| I | 0.01 | 40 | 0.86 | 0.47 | 211 |

When γ is lower than 0.73, the DSC peak temperature will be lower than 213° C., the thermal safety of high-nickel ternary positive electrode material is poor. When γ value≥1.07, the DSC peak temperature≥221° C., the thermal safety performance is more excellent, when γ value≥7.74, the DSC peak temperature ≥233° C., the thermal safety performance is very excellent, and when γ value=13.13, the DSC peak temperature is as high as 240° C.

The above are only preferred embodiments of the present application, it should be noted that, for persons of ordinary skill in the art, several improvements and modifications can be made without deviating from the principle of the application, and these improvements and modifications shall also be considered as the protection scope of the present application.

What is claimed is:

1. A high-nickel ternary positive electrode material having high thermal safety, therein the high-nickel ternary positive electrode material has a chemical formula of:
LiNiₐCo_{b}Mn_{c}M_{d}QₑO₂,
wherein 0.8<a<0.95, b<0.2,c<0.2,d<0.1,a+b+c+d+e=1,
M is a doping element, selected from one or more of Sr, Ti, Al, Zr, Y, Ba, Mg, or Mo,
Q is a coating element, selected from one or both of Sr or Ti,
the high-nickel ternary positive electrode material satisfies a relationship shown in Formula I:
$$γ = α * D 104 / K \qquad Formula I$$
in Formula I, 0.73≤γ≤14.00, γ is a thermal safety coefficient of the high-nickel ternary positive electrode material, α is a cross-sectional porosity of the high-nickel ternary positive electrode material, D104 is a parameter of the high-nickel ternary positive electrode material in a XRD test, and K is a thermal conductivity of the high-nickel ternary positive electrode material.

2. The high-nickel ternary positive electrode material according to claim 1, wherein 45≤D104≤70.

3. The high-nickel ternary positive electrode material according to claim 1, wherein 1% ≤α≤5%.

4. The high-nickel ternary positive electrode material according to claim 1, wherein 0.1 W/(m·K)≤K≤0.6 W/(m·K).

5. The high-nickel ternary positive electrode material according to claim 1, comprising a core, and a coating layer, and the coating layer has a thermal conductivity of ≤0.2 W/(m·K).

6. A method for preparing the high-nickel ternary positive electrode material according to claim 1, comprising the following steps:
A) mixing a ternary hydroxide precursor NiₐCo_{b}Mn_{c}(OH)₂, a lithium source, and a compound containing the element M, and then sintering under an oxygen atmosphere to obtain a sintered product;
B) washing and drying the sintered product, mixing the sintered product with a compound containing the element Q, and then sintering under the oxygen atmosphere to obtain the high-nickel ternary positive electrode material.

7. The method for preparing the high-nickel ternary positive electrode material according to claim 6, wherein 45≤D104≤70.

8. The method for preparing the high-nickel ternary positive electrode material according to claim 6, wherein 1% ≤α≤5%.

9. The method for preparing the high-nickel ternary positive electrode material according to claim 6, wherein 0.1W/(m·K)≤K≤0.6 W/(m·K).

10. The method for preparing the high-nickel ternary positive electrode material according to claim 6, comprising a core, and a coating layer, and the coating layer has a thermal conductivity of ≤0.2 W/(m·K).

11. The method according to claim 6, wherein the lithium source is selected from LiOH;
the compound containing the element M is selected from one or more of Al(OH)₃, Al₂O₃, SrO, TiO₂, ZrO₂, Zr(OH)₄, Y₂O₃, BaCO₃, MgO, or MoO₃;
the compound containing the element Q is selected from TiO₂, SrO, or SrTiO₃.

12. The method according to claim 6, wherein in step A), the sintering is performed at a temperature of 740° C.-820°° C. for a time of 10-15 hours.

13. The method according to claim 6, wherein in step B), the sintering is performed at a temperature of 350-500°° C. for a time of 8-12 hours.

14. A lithium ion battery comprising the high-nickel ternary positive electrode material according to claim 1.

15. A lithium ion battery comprising the high-nickel ternary positive electrode material prepared by the method according to claim 6.
